(19) United States
(12) Patent Application Publication
(10) Pub. No.: US 2012/0102964 A1
(43) Pub. Date: May 3, 2012

(54) TURBOMACHINE INCLUDING A CARBON DIOXIDE (CO2) CONCENTRATION CONTROL SYSTEM AND METHOD

(75) Inventors: Pugalenthi Nandagopal, Bangalore (IN); Chetan Madhav Joshi, Bangalore (IN); Manikandan Thiyagarajan, Bangalore (IN); Anantha Ramesh Rangaswamy, Bangalore (IN)

(73) Assignee: GENERAL ELECTRIC COMPANY, Schenectady, NY (US)

(21) Appl. No.: 12/915,341

(22) Filed: Oct. 29, 2010

(51) Int. Cl. F02C 1/00; F02C 7/08

(52) U.S. Cl. 60/772; 60/39.5

(57) ABSTRACT

A turbomachine includes a compressor section, a turbine section operatively connected to the compressor section, a combustor fluidly connected between the compressor section and the turbine section, and a carbon dioxide (CO₂) extraction system fluidly connected to the combustor. The CO₂ extraction system includes a CO₂ separator. The CO₂ separator separates a CO₂ laden inlet gas stream into a first gas stream and a second gas stream. The first gas stream is substantially free of CO₂ and the second gas stream comprises CO₂. The first gas stream is directed to the combustor and the second gas stream is passed through a discharge conduit.

### BACKGROUND OF THE INVENTION

The subject matter disclosed herein relates to the art of turbomachines and, more particularly, to a system for controlling carbon dioxide (CO₂) concentration in a turbomachine.

Metal foundries often use a blast furnace to reduce iron ore with coke to a metallic iron. The blast furnace produces blast furnace gas which has a low heating value. The blast furnace gas is often used as a fuel to power various machines in the foundry. For example, the blast furnace gas may be used to power turbomachines that operate generators that produce electricity for the foundry. That is, compressed air from a compressor section is mixed with the blast furnace gas, ignited in a combustor and directed into a turbine section of the turbomachine. The turbine section is coupled to a generator that is configured to produce electrical energy for the foundry. Generally, blast furnace gas is about 60% nitrogen, 18-20% carbon dioxide and some oxygen with the remainder being carbon monoxide. Being a lean fuel, blast furnace gas is introduced into a turbomachine combustor at a high flow rate. The high flow rate may cause the compressor section to reach a stall limit. As such, air is extracted from the compressor section and fed into an exhaust portion of the turbine section to prevent compressor stall.

### BRIEF DESCRIPTION OF THE INVENTION

According to one aspect of the invention, a turbomachine includes a compressor section, a turbine section operatively connected to the compressor section, a combustor fluidly connected between the compressor section and the turbine section, and a carbon dioxide (CO₂) extraction system fluidly connected to the combustor. The CO₂ extraction system includes a CO₂ separator. The CO₂ separator separates a CO₂ laden inlet gas stream into a first gas stream and a second gas stream. The first gas stream is substantially free of CO₂ and the second gas stream comprises CO₂. The first gas stream is directed to the combustor and the second gas stream is passed through a discharge conduit.

According to another aspect of the invention, a blast furnace gas power plant includes a blast furnace including an exhaust portion, and a furnace gas compressor fluidly connected to the exhaust portion of the blast furnace. The furnace gas compressor pressurizes blast furnace gas from the blast furnace. The gas furnace power plant also includes a turbomachine having a compressor section, a turbine section operatively connected to the compressor section, and a combustor fluidly connected between the compressor section and the turbine section. A carbon dioxide (CO₂) extraction system is fluidly connected to the furnace gas compressor, and the combustor. The CO₂ extraction system includes a CO₂ separator. The CO₂ separator separates a CO₂ laden inlet gas stream from the furnace gas compressor into a first gas stream and a second gas stream. The first gas stream is substantially free of CO₂ and the second gas stream comprises CO₂. The first gas stream is directed to the combustor and the second gas stream is passed through a discharge conduit.

According to yet another aspect of the invention, a method of operating a blast furnace gas power plant includes generating blast furnace gas containing carbon dioxide (CO₂), guiding the blast furnace gas into a furnace gas compressor to form pressurized blast furnace gas, passing the pressurized blast furnace gas into a CO₂ extraction system, extracting CO₂ from the pressurized blast furnace gas to form a first pressurized gas stream substantially free of CO₂ and a second pressurized gas stream comprising CO₂, and directing the first pressurized gas stream into a combustor of a turbomachine.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a blast furnace gas power plant including a turbomachine having a system for controlling CO₂ concentration in accordance with one aspect of an exemplary embodiment;

FIG. 2 is a schematic view of a blast furnace gas power plant including a turbomachine having a system for controlling CO₂ concentration in accordance with another aspect of the exemplary embodiment; and

FIG. 3 is a schematic view of a blast furnace gas power plant including a turbomachine having a system for controlling CO₂ concentration in accordance with still another aspect of the exemplary embodiment.

The detailed description explains embodiments of the invention, together with advantages and features, by way of example with reference to the drawings.

### DETAILED DESCRIPTION OF THE INVENTION

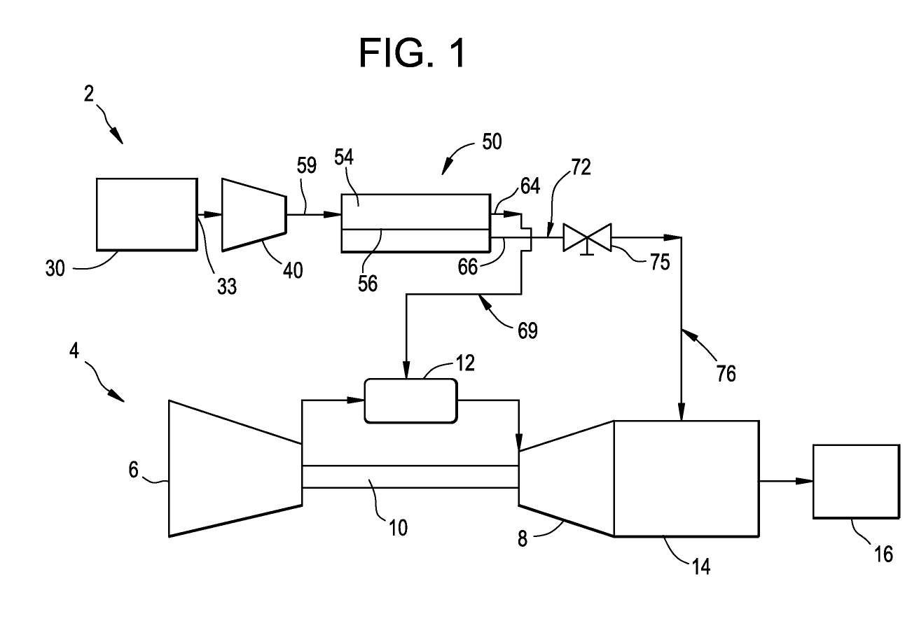

With reference to FIG. 1, a blast furnace gas (BFG) power plant in accordance with an exemplary embodiment is indicated generally at 2. BFG power plant 2 includes a turbomachine 4 having a compressor section 6 and a turbine section 8 operatively connected by a common compressor/turbine shaft 10. Compressor section 6 and turbine section 8 are fluidly connected by a combustor 12. Turbine section 8 includes an exhaust portion 14 that is fluidly connected to a heat recovery steam generator (HRSG) 16. BFG power plant 2 also includes a blast furnace 30 having an exhaust portion 33 that is fluidly connected to a furnace gas compressor (FGC) 40. With this arrangement, furnace gas from blast furnace 30 is pressurized by FGC 40 and passed to combustor 12 as a fuel. The pressurized furnace gas is mixed with an amount of extraction air from compressor section 6 and ignited to form combustion gases. The combustion gases are then passed to a first stage of turbine section 8. Turbine section 8 converts thermal energy from the combustion gases to mechanical/rotational energy that is used to operate a generator that provides power for a blast furnace facility.

In accordance with an exemplary embodiment, prior to reaching combustor 12, carbon dioxide (CO₂) is removed from the pressurized blast furnace gas. Removing CO₂ from the pressurized blast furnace gas reduces the amount of extraction air required from compressor section 6 thereby allowing higher firing temperatures in combustor 12. Lowering the amount of extraction air needed for combustion and raising the firing temperatures in the combustor improves gas turbine performance. In order to remove the CO₂, the pressurized blast furnace gas is passed through a carbon dioxide extraction system 50. Carbon dioxide extraction system 50 includes a carbon dioxide separator 54 which, in accordance with one aspect of the exemplary embodiment, takes the form of a carbon dioxide membrane 56.

In accordance with the exemplary embodiment, pressurized blast furnace gas 59 is passed from FGC 40 into carbon dioxide extraction system 50. Carbon dioxide separator 54 divides pressurized blast furnace gas 59 into a first pressurized gas stream 64 that is substantially free of carbon dioxide and a second pressurized gas stream 66 that comprises carbon dioxide. “Substantially free” should be understood to mean, in accordance with one aspect of the exemplary embodiment, first pressurized gas stream 64 is 95% free of carbon dioxide. In accordance with another aspect of the exemplary embodiment, first pressurized gas stream 64 is 98% free of carbon dioxide. In accordance with yet another aspect of the exemplary embodiment, first pressurized gas stream 64 is 99% free of carbon dioxide. In accordance with still another aspect of the exemplary embodiment, first pressurized gas stream 64 is completely, 100% free of carbon dioxide.

First pressurized gas stream 64 is passed through a fuel conduit 69 and on to combustor 12 to be used as fuel in turbomachine 4. Second pressurized gas stream 66 is passed through a discharge conduit 72 having a control valve member 75 and, in accordance with the exemplary embodiment shown, directed to exhaust portion 14 of turbine section 8 via an exhaust conduit 76. In further accordance with the exemplary embodiment, control valve member 75 is selectively opened/closed to establish a desired flow rate of second pressurized gas stream 66. Controlling the flow rate of second pressurized gas stream 66, establishes a desired level of carbon dioxide in first pressurized gas stream 64. Controlling the level of CO₂ in the first pressurized gas stream allows for a more flexible control of combustor 12 thereby further improving the performance and emission compliance of turbomachine 4.

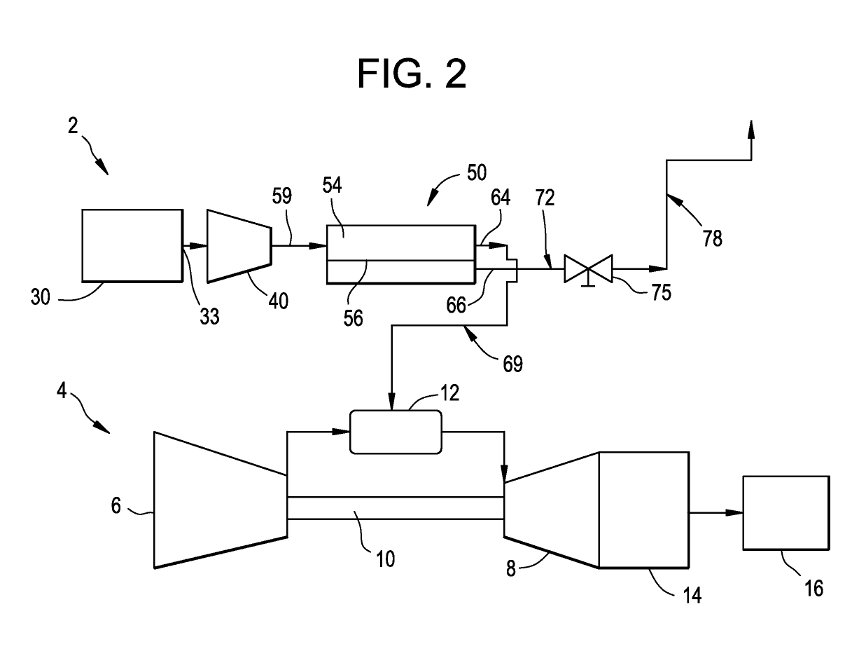

Reference will now be made to FIG. 2, wherein like reference numbers represent corresponding parts in the respective views, in describing another aspect of the exemplary embodiment. In accordance with the arrangement shown, second pressurized gas stream 66 is directed from discharge conduit 72 into secondary discharge conduit 78. From secondary discharge conduit 78, second pressurized gas stream 66 may either be released to ambient, or passed to another system for storage or other uses. In this arrangement, instead of passing second pressurized gas steam 66 in exhaust portion 14, the entrained carbon dioxide may be captured and used for other purposes in order to extract additional utility from BFG power plant 2.

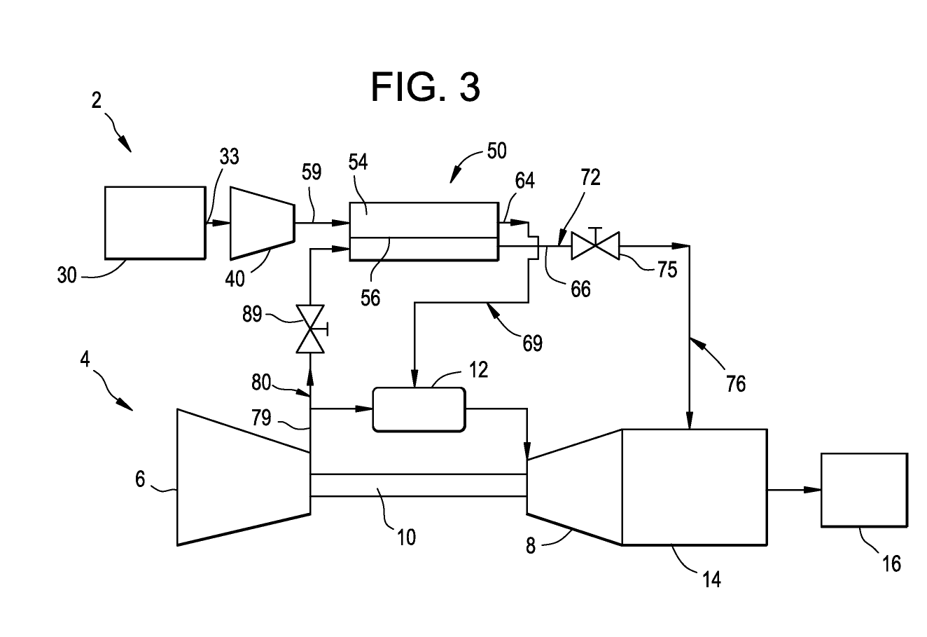

Reference will now be made to FIG. 3, wherein like reference numbers represent corresponding parts in the respective views, in describing yet another aspect of the exemplary embodiment. In accordance with the arrangement shown, in addition to receiving pressurized blast furnace gas 59 from FGC 40, carbon dioxide extraction system 50 receives extraction air 79 from compressor section 6. More specifically, compressor section 6 is fluidly connected to carbon dioxide separator 54 by an extraction air conduit 80. Extraction air conduit 80 is provided with an extraction air control valve member 89 that is selectively opened/closed to control a flow rate of extraction air to deliver extraction air 79 from compressor section 6 to carbon dioxide separator 54. With this arrangement, extraction air control valve member 89 may be operated separately and/or in conjunction with control valve member 75 to adjust the amount of carbon dioxide in first pressurized gas stream 64. As shown, second pressurized gas stream 66 may be directed to exhaust portion 14 of turbine section 6, or passed to a collection system for alternative uses.

At this point it should be understood that the exemplary embodiments provide a system for controlling an amount of carbon dioxide in a fuel gas stream of a blast furnace power plant. Controlling the amount of CO₂ in the furnace gas provided to the combustor reduces the amount of extraction air required from the compressor section. By lowering the amount of CO2 in the combustible mixture, it is possible to employ higher firing temperatures in the combustor. Lowering the amount of extraction air needed for compressor protection and raising the firing temperatures in the combustor improves gas turbine performance.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine comprising:
a compressor section;
a turbine section operatively connected to the compressor section;
a combustor fluidly connected between the compressor section and the turbine section; and
a carbon dioxide (CO₂) extraction system fluidly connected to the combustor, the CO₂ extraction system including a CO₂ separator, the CO₂ separator separating a CO₂ laden inlet gas stream into a first gas stream and a second gas stream, the first gas stream being substantially free of CO₂ and the second gas stream comprising CO₂, the first gas stream being directed to the combustor and the second gas stream being passed through a discharge conduit.

2. The turbomachine according to claim 1, further comprising: a discharge gas valve member arranged in the discharge conduit, the discharge gas valve member being selectively opened to control CO₂ concentration in the first gas stream.

3. The turbomachine according to claim 2, wherein the discharge conduit is fluidly connected to the turbine section.

4. The turbomachine according to claim 3, wherein the discharge conduit is fluidly connected to an exhaust portion of the turbine section.

5. The turbomachine according to claim 1, further comprising: an extraction air conduit fluidly connecting the compressor section and the CO₂ extraction system.

6. The turbomachine according to claim 5, further comprising: an extraction air valve member arranged in the extraction air conduit, the extraction air valve member being selectively opened to control CO₂ concentration in the first gas stream.

7. The turbomachine according to claim 1, wherein the CO₂ separator comprises a CO₂ membrane.

8. A blast furnace gas power plant comprising:
a blast furnace including an exhaust portion;
a furnace gas compressor fluidly connected to the exhaust portion of the blast furnace, the furnace gas compressor pressuring blast furnace gas from the blast furnace;
a turbomachine including a compressor section, a turbine section operatively connected to the compressor section; and a combustor fluidly connected between the compressor section and the turbine section; and
a carbon dioxide (CO₂) extraction system fluidly connected to the furnace gas compressor, the combustor, the CO₂ extraction system including a CO₂ separator, the CO₂ separator separating a CO₂ laden inlet gas stream from the furnace gas compressor into a first gas stream and a second gas stream, the first gas stream being substantially free of CO₂ and the second gas stream comprising CO₂, the first gas stream being directed to the combustor and the second gas stream being passed through a discharge conduit.

9. The blast furnace gas power plant according to claim 8, further comprising: a discharge gas valve member arranged in the discharge conduit, the discharge gas valve member being selectively opened to control CO₂ concentration in the first gas stream.

10. The blast furnace gas power plant according to claim 9, wherein the discharge conduit is fluidly connected to the turbine section.

11. The blast furnace gas power plant according to claim 10, wherein the discharge conduit is fluidly connected to an exhaust portion of the turbine section.

12. The blast furnace gas power plant according to claim 8, further comprising: an extraction air conduit fluidly connecting the compressor section and the CO₂ extraction system.

13. The blast furnace gas power plant according to claim 12, further comprising: an extraction air valve member arranged in the extraction air conduit, the extraction air valve member being selectively opened to control CO₂ concentration in the first gas stream.

14. The blast furnace gas power plant according to claim 8, wherein the CO₂ separator comprises a CO₂ membrane.

15. A method of operating a blast furnace gas power plant, the method comprising:
generating blast furnace gas containing carbon dioxide (CO₂);
guiding the blast furnace gas into a furnace gas compressor to form pressurized blast furnace gas;
passing the pressurized blast furnace gas into a CO₂ extraction system;
extracting CO₂ from the pressurized blast furnace gas to form a first pressurized gas stream substantially free of CO₂ and a second pressurized gas stream comprising CO₂; and
directing the first pressurized gas stream into a combustor of a turbomachine.

16. The method of claim 15, further comprising: discharging the second pressurized gas stream from the CO₂ extraction system.

17. The method of claim 16, further comprising: adjusting a flow rate of the second pressurized gas stream to control an amount of CO₂ in the first pressurized gas stream.

18. The method of claim 16, wherein discharging the second pressurized gas stream from the CO₂ extraction system comprises passing the second pressurized gas stream into a turbine section of the turbomachine.

19. The method of claim 15, further comprising: passing extraction air from a compressor section of the turbomachine into the CO₂ extraction system.

20. The method of claim 19, further comprising: adjusting a flow rate of the extraction air into the CO₂ extraction system to control an amount of CO₂ in the first pressurized gas stream.
